(19) United States
(12) Patent Application Publication
(10) Pub. No.: US 2018/0019643 A1
(43) Pub. Date: Jan. 18, 2018

(54) BLADE FOR A FAN

(71) Applicant: Siemens Aktiengesellschaft, Munich (DE)

(72) Inventors: Mario Brockschmidt, Essen (DE); Rene Höhner, Gelsenkirchen (DE); Bora Kocdemir, Essen (DE); Alexander Litinsky, Düsseldorf (DE); Andrey Mashkin, Köln (DE); Friedhelm Pohlmann, Essen (DE); Guido Schmidt, Leichlingen (DE); Christian Staubach, Marl (DE); Simon Voß, Mülheim (DE)

(73) Assignee: Siemens Aktiengesellschaft, Munich (DE)

(21) Appl. No.: 15/523,221

(22) PCT Filed: Oct. 26, 2015
(86) PCT No.: PCT/EP2015/074689

§ 371 Date: Apr. 28, 2017

(30) Foreign Application Priority Data
Nov. 11, 2014 (EP) 14192625.3

(51) Int. Cl. H02K 9/06; B29D 99/00; B29C 45/00; F04D 29/38; F04D 29/02; B29K 309/00; B29L 31/08

(52) U.S. Cl. CPC H02K 9/06; F04D 29/388; B29D 99/0025; F04D 29/023; B29C 45/0005; B29L 2031/08; B29K 2309/00; F05D 2300/30; F05D 2300/43; F05D 2300/603; F05D 2300/614

(57) ABSTRACT

A blade for a fan that can be arranged on a rotor shaft of a rotor of a rotating electric machine, in particular a generator, wherein the blade is at least partially formed from a fiber composite material that has a polymer matrix with mineral fibers embedded therein. A method for producing a blade for a fan arrangeable on a rotor shaft of a rotor of a rotating electrical machine, in particular a generator, wherein the blade is produced using an injection molding method, and wherein a fiber composite material of a polymer matrix with mineral fibers embedded therein is used as injection molding material.

### CROSS REFERENCE TO RELATED APPLICATIONS

This application is the US National Stage of International Application No. PCT/EP2015/074689 filed Oct. 26, 2015, and claims the benefit thereof. The International Application claims the benefit of European Application No. EP14192625 filed Nov. 11, 2014. All of the applications are incorporated by reference herein in their entirety.

### FIELD OF INVENTION

The invention relates to a blade for a fan arrangeable on a rotor shaft of a rotor of a rotating electrical machine, in particular a generator.

Furthermore, the invention relates to a fan for cooling a rotating electrical machine, in particular a generator, wherein the fan is arrangeable on a rotor shaft of a rotor of the rotating electrical machine.

The invention further relates to a method for producing a blade for a fan arrangeable on a rotor shaft of a rotor of a rotating electrical machine, in particular a generator.

### BACKGROUND OF INVENTION

Rotating electrical machines in the form of generators are used for example in power stations to generate electrical energy. During operation of a rotating electrical machine, heat is necessarily generated in the stator and/or the rotor or the winding arranged respectively thereon of the rotating electrical machine. This waste heat arises during the conversion of mechanical energy into electrical energy by means of the rotating electrical machine.

To ensure safe operation of the rotating electrical machine, the heat generated in a stator and/or a rotor of a rotating electrical machine has to be dissipated from the rotating electrical machine. This is necessary in particular because electrical insulation is present on the stator and/or the rotor which might deteriorate once a given temperature is reached, so leading to more rapid aging. The more heat is dissipated from a rotating electrical machine, the greater the possible utilization of the rotating electrical machine, which is associated with a corresponding increase in performance.

Conventionally, air, hydrogen, water or a combination of these coolants may be used to dissipate heat from a rotating electrical machine or to cool the stator and/or the rotor, wherein the coolant flows through the rotating electrical machine.

To cool a rotating electrical machine with air or hydrogen, a single- or multistage fan may be used on the rotor shaft of the rotor of the rotating electrical machine, which fan operates in suction or pressure operation and with which a coolant flow may be produced through the rotating electrical machine. A single-stage fan comprises a single rotor blade ring arranged on the rotor shaft and having a plurality of rotor blades. A multistage fan further comprises at least one stationarily mounted guide vane ring with a plurality of guide vanes.

It is known to produce fan guide vanes from austenitic stainless steel and fan rotor blades from martensitic stainless steel. In this case, a guide vane or rotor blade is conventionally produced by milling from a solid material.

### SUMMARY OF INVENTION

It is an object of the invention to provide a blade for a fan arrangeable on a rotor shaft of a rotor of a rotating electrical machine which is cheaper to produce compared with conventional blades and has a higher mechanical loading capacity.

In the case of the blade according to the invention for a fan arrangeable on a rotor shaft of a rotor of a rotating electrical machine, in particular a generator, the blade is formed at least in part from a fiber composite material comprising a polymer matrix with mineral fibers embedded therein.

According to the invention, the blade is not, as is conventional, made from a steel, but rather partially or completely from a fiber composite material comprising the polymer matrix with mineral fibers embedded therein. This fiber composite material is markedly cheaper than a steel material. In addition, in the case of the use according to the invention of the fiber composite material, the blade may be produced using a less expensive production method, for example by an injection molding method. This is cheaper in particular relative to the conventional milling of a blade from a solid steel material, in which a relatively large quantity of scrap material necessarily arises, in particular since the duration of the production process may be significantly shortened.

Various mineral fibers have the advantage that they have a higher tensile strength than steel, which gives the blade a high loading capacity and makes it very durable.

Use according to the invention of the fiber composite material additionally has the advantage that the weight of the blade may be reduced relative to a blade made of a steel material, which has a positive effect on the operation of a correspondingly equipped rotating electrical machine.

The mineral fibers advantageously take the form at least in part of basalt fibers. Basalt fibers have a lower specific weight than steel, have a tensile strength which is several times higher than that of steel and can be produced markedly more cheaply than for example carbon fibers. Carbon fibers additionally have a markedly lower tensile strength than basalt fibers. Basalt fibers may for example have a tensile strength of around 4000 MPa. Basalt is a natural rock and is contained in the earth's crust in a proportion of around 13% and is thus sufficiently abundant. The mineral fibers may also take the form wholly of basalt fibers.

The polymer matrix is advantageously a cured epoxy resin, in particular bisphenol A diglycidylether, bisphenol F diglycidylether and/or cycloaliphatic epoxy resins. The epoxy resin may be cured with an aminic curing agent, in particular diethylenetriamine, and/or a carboxylic anhydride, in particular hexahydrophthalic anhydride.

The blade advantageously takes the form of a rotor blade or a guide vane.

The fan according to the invention for cooling a rotating electrical machine, in particular a generator, which fan is arrangeable on a rotor shaft of a rotor of the rotating electrical machine, comprises at least one blade ring arrangeable rotationally on the rotor shaft and formed of blades, wherein the blades are configured according to one of the above-stated configurations or any desired combination thereof.

The advantages stated above with reference to the blade apply mutatis mutandis to the fan. The blade ring may be a rotor blade ring or a guide vane ring. The fan may be of single-, two- or multistage configuration. All the blades of the fan may also be correspondingly configured.

In the method according to the invention for producing a blade for a fan arrangeable on a rotor shaft of a rotor of a rotating electrical machine, in particular a generator, the blade is produced using an injection molding method, wherein a fiber composite material comprising a polymer matrix with mineral fibers embedded therein is used as injection molding material.

The polymer matrix is advantageously an epoxy resin, in particular bisphenol A diglycidylether, bisphenol F diglycidylether and/or cycloaliphatic epoxy resins. The epoxy resin is cured in the injection molding method. This may be performed with an aminic curing agent, in particular diethylenetriamine, and/or a carboxylic anhydride, in particular hexahydrophthalic anhydride.

The advantages stated above with reference to the blade apply mutatis mutandis to the method. An injection molding method is markedly cheaper than producing a blade conventionally from a solid steel material by means of milling. The blade may undergo post-treatment once the injection molding method has been carried out.

The mineral fibers used are advantageously at least in part basalt fibers. The advantages stated above with reference to the corresponding configuration of the blade apply mutatis mutandis to this configuration.

### BRIEF DESCRIPTION OF THE DRAWINGS

An embodiment of a method according to the invention and an embodiment of a blade according to the invention are explained below on the basis of the appended schematic drawings, in which:

FIG. 1 is a representation of an exemplary embodiment of a method according to the invention; and

FIG. 2 is a perspective representation of an exemplary embodiment of a blade according to the invention.

### DETAILED DESCRIPTION OF INVENTION

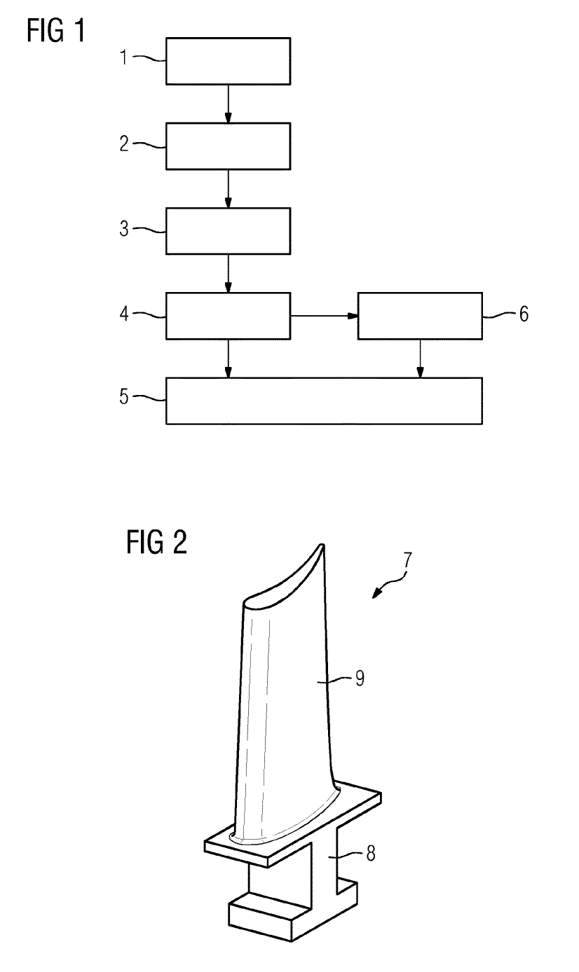

FIG. 1 shows a representation of an exemplary embodiment of a method according to the invention for producing a blade (not shown) for a fan arrangeable on a rotor shaft of a rotor of a rotating electrical machine in the form of a generator.

In step 1 a polymeric material is mixed with basalt fibers, to obtain a homogeneous mixture of the polymeric material and the basalt fibers. In step 2 the homogeneous mixture is kneaded to obtain a fiber composite material which comprises a polymer matrix with basalt fibers embedded therein. In step 3 the blade is produced using an injection molding method, wherein the fiber composite material produced in step 2 is used as the injection molding material. In step 4 the blade produced in step 3 is heated and thereby finished, for which purpose a walking beam furnace may be used, for example. In step 5 a blade finished in step 4 may be put to use or warehoused. Alternatively, in step 6 the blade finished in step 4 may undergo post-processing, before it is put to use or warehoused in step 5.

FIG. 2 is a perspective representation of an exemplary embodiment of a blade 7 according to the invention for a fan (not shown) arrangeable on a rotor shaft (not shown) of a rotor of a rotating electrical machine. The blade 7 is formed at least in part of a fiber composite material, which comprises a polymer matrix with mineral fibers embedded therein. The mineral fibers take the form at least in part of basalt fibers. The blade 7 takes the form of a rotor blade. The blade 7 comprises a blade root 8, by means of which the blade 7 may be attached to the rotor shaft. Furthermore, the blade 7 comprises a blade leaf 9 protruding from the blade root 8.

Although the invention has been illustrated and described in greater detail with reference to the preferred exemplary embodiments, the invention is not restricted by the disclosed examples and other variations may be derived therefrom by a person skilled in the art without going beyond the scope of protection of the invention.

1. A blade for a fan arrangeable on a rotor shaft of a rotor of a rotating electrical machine, comprising:
a fiber composite material which forms the blade at least in part,
wherein the fiber composite material comprises a polymer matrix with mineral fibers embedded therein.

2. The blade as claimed in claim 1,
wherein the mineral fibers take the form at least in part of basalt fibers.

3. The blade as claimed in claim 1,
wherein the blade takes the form of a rotor blade or a guide vane.

4. A fan for cooling a rotating electrical machine, wherein the fan is arrangeable on a rotor shaft of a rotor of the rotating electrical machine, the fan comprising:
at least one blade ring arrangeable rotationally on the rotor shaft and formed of blades,
wherein the blades are configured according to claim 1.

5. A method for producing a blade for a fan arrangeable on a rotor shaft of a rotor of a rotating electrical machine, the method comprising:
producing a blade using an injection molding method, and
using a fiber composite material comprising a polymer matrix with mineral fibers embedded therein as injection molding material.

6. The method as claimed in claim 5,
wherein the mineral fibers used are at least in part basalt fibers.

7. The blade as claimed in claim 1,
wherein the rotating electrical machine comprises a generator.

8. The fan according to claim 4,
wherein the rotating electrical machine comprises a generator.

9. The method according to claim 5,
wherein the rotating electrical machine comprises a generator.
